(19) United States
(12) Patent Application Publication
(10) Pub. No.: US 2006/0272464 A1
(43) Pub. Date: Dec. 7, 2006

(54) Circular saw machine having dust collectors

(75) Inventor: Jung-Huo Chen, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: Rexon Industrial Corp., Ltd., Taichung Hsien (TW)

(21) Appl. No.: 11/446,401

(22) Filed: Jun. 5, 2006

(30) Foreign Application Priority Data
Jun. 3, 2005 (TW) 94209359

(51) Int. Cl. B26D 7/06; B27B 27/04

(52) U.S. Cl. 83/100; 83/477.2

(57) ABSTRACT

A circular saw machine includes a body having a base, a worktable mounted on the base and a receiving space defined in the base, a saw blade placed in the receiving space and adjusted through the worktable, a motor assembly having a rotating shaft extended through a center of the saw blade, a blade holder received inside the receiving space, connected to the body and holding the rotating shaft, a control assembly coupled to the blade holder for moving the blade holder so as to adjust a height of the saw blade above the worktable, a first dust collector fixedly connected to the blade holder and covering a part rim of the saw blade, and a second dust collector covering another part rim of the saw blade and movably overlapping with the first dust collector.

### BACKGROUND OF THE INVENTION

1. Field of the Invention

The present invention relates to a circular saw machine, and more particularly to such a circular saw machine having dust collectors.

2. Description of the Related Art

A regular circular saw machine has a dust collector that stops workpiece chips and dust from scattering during sawing a wood workpiece, enabling workpiece chips and dust to be collected and expelled to the outside of the circular saw machine and further to be drawn into a vacuum cleaner to keep the inside of the circular saw machine clean.

The dust collector of a conventional circular saw machine is a full-cover and un-moveable corresponding to a saw blade. It is directly fixed inside the circular saw machine and fully covers the saw blade inside the circular saw machine. Because the user must frequently adjust the height of the saw blade above the circular saw machine to satisfy different cutting conditions, the dust collector must have a certain size capable of covering the area around the saw blade that allows moving the saw blade inside. Therefore, this dust collector occupies much space inside the circular saw machine. Further, in order to be fixed inside the circular saw machine, the outer shape and structure of the dust cove are complicated.

### SUMMARY OF THE INVENTION

The present invention has been accomplished under the circumstances in view. It is therefore one object of the present invention to provide a circular saw machine, which has dust collectors. The dust collectors are relatively movable according to lifting or lowering the saw blade so as to form a coupled covering over the saw blade in any operation. As a result, the workpiece chips and dust during operation of the circular saw machine can be well collected and carried out of the circular saw machine. Furthermore, the dust collectors have a simple structure and are easy to be installed.

To achieve the object of the present invention, the circular saw machine comprises a body having a base, a worktable mounted on the base and a receiving space defined in the base, a saw blade placed in the receiving space and adjusted through the worktable, a motor assembly having a rotating shaft extended through a center of the saw blade, a blade holder received inside the receiving space, connected to the body and holding the rotating shaft, a control assembly coupled to the blade holder for moving the blade holder so as to adjust a height of the saw blade above the worktable, a first dust collector fixedly connected to the blade holder and covering a part rim of the saw blade, and a second dust collector covering another part rim of the saw blade and movably overlapping with the first dust collector.

The first dust collector can be designed to have a rigid guard fixed on the blade holder, and a flexible guard connecting with the rigid guard and adjacent to a bottom side of said worktable. The rigid guard is inserted into an inner space of said second dust collector, and hence, when lifting or lowering the saw blade, the dust collectors move relatively and keep overlapping.

### BRIEF DESCRIPTION OF THE DRAWINGS

FIG. 1 is a schematic sectional side view of a circular saw machine in accordance with a embodiment of the present invention.

FIG. 2 is a sectional view taken along line 2-2 of FIG. 1.

FIG. 3 is similar to FIG. 1 but shows the position of the dust collectors after lowering the saw blade.

FIG. 4 is a schematic sectional side view of a circular saw machine in accordance with another embodiment of the present invention.

FIG. 5 is a sectional view taken along line 5-5 of FIG. 4.

### DETAILED DESCRIPTION OF THE INVENTION

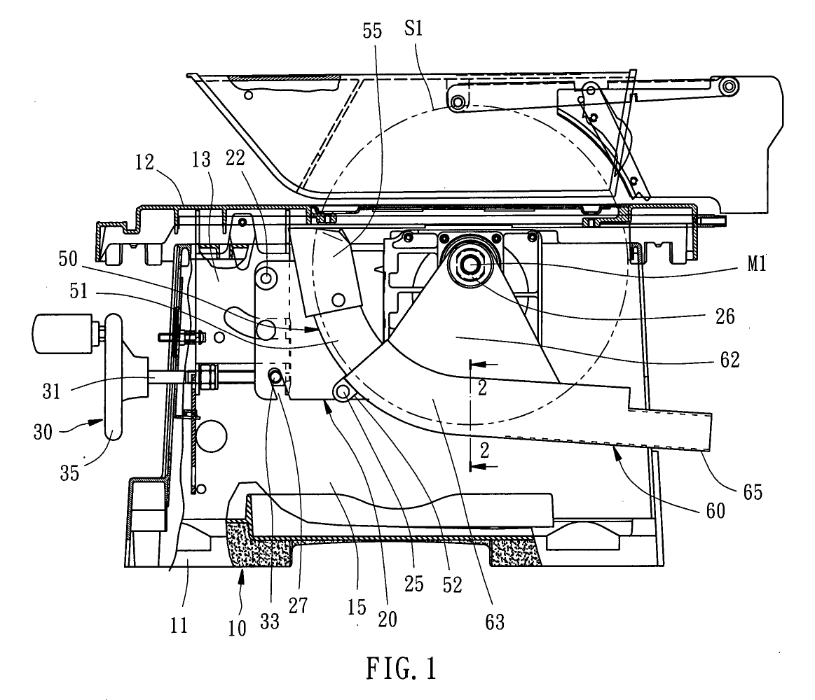

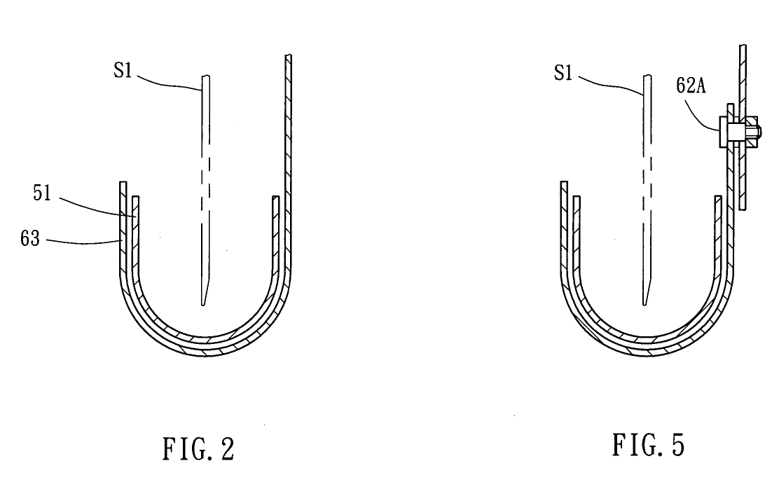

Referring to FIGS. 1 and 2, a circular saw machine is shown comprising the following elements:

A body 10 has a base 11, a worktable 12 mounted at the top side of the base 11, a locating block 13 provided inside the base 11, and a receiving space 15 defined in the base 11.

A saw blade S1 is placed in said receiving space 15 and can be adjusted through said worktable 12.

A motor assembly has a rotating shaft M1 extended through a center of said saw blade for rotating the saw blade S1.

A blade holder 20 is received inside said receiving space 15 and has a connection portion 22 pivotally coupled to the locating block 13 of the body 10. The motor assembly is mounted on the blade holder 20 so that the blade holder 20 holds the rotating shaft M1. The blade holder 20 further has a first dust collector mounting portion 25, a second dust collector mounting portion 26, and coupling means, for example, two coupling groove 27.

A control assembly 30 has a threaded rod 31, a link part 33 and a wheel 35. The two terminal portions of the link part 33 insert respectively into the two coupling grooves 27 of the blade holder 20. The threaded rod 31 screws through the middle portion of the link part 33. The wheel 35 is fixed on the end of threaded rod 31 and can be rotated by the user to cause rotation of the threaded rod 31 to further cause movement of the link part 33 along the threaded rod 31. The movement of the link part 33 rotates pivotally the blade holder 20 so as to adjust a height of the saw blade S1 above the worktable 12.

A first dust collector 50 has a rigid guard 51, a mounting portion 52 extended from the rigid guard 51 and fixedly fastened to the first dust collector mounting portion 25 of the blade holder 20, and a flexible guard 55 connected to up end of the rigid guard 51 and extended toward and adjacent to the bottom side of the worktable 12 of the body 10. The first dust collector 50 is disposed near the saw blade S1 and covers a part rim of the saw blade S1. Moreover, the first dust collector 50 has a first curve defined by a first radius around a center of the rotating shaft M1 and the first radius of the first curve is larger than a radius of the rim of the saw blade S1.

A second dust collector 60 has a mounting portion 62, a guarding portion 63 and a dust pipe connect portion 65. The mounting portion 62 is extended from the guarding portion 63 and pivotally connected to the second dust collector mounting portion 26 of the blade holder 20, and a pivotal center of the second dust collector 60 is the same as the center of the rotating shaft. The guarding portion 63 overlaps with the rigid guard 51 of the first dust collector 50, for example, inserting the rigid guard 51 of the first dust collector 50 into an inner space of the guarding portion 63, and can move relative to the rigid guard 51. The guarding portion 63 is disposed near the saw blade S1 and covers another part rim of the saw blade S1. The dust pipe connect portion 65 is extended from the guarding portion 63 and through the base 11 for connection with a dust pipe of a vacuum cleaner (not shown). The guarding portion 63 of the second dust collector 60 has a second curve defined by a second radius around the center of the rotating shaft and the second radius of the second curve is larger than the first radius of the first curve.

The operation of the present invention is outlined hereinafter.

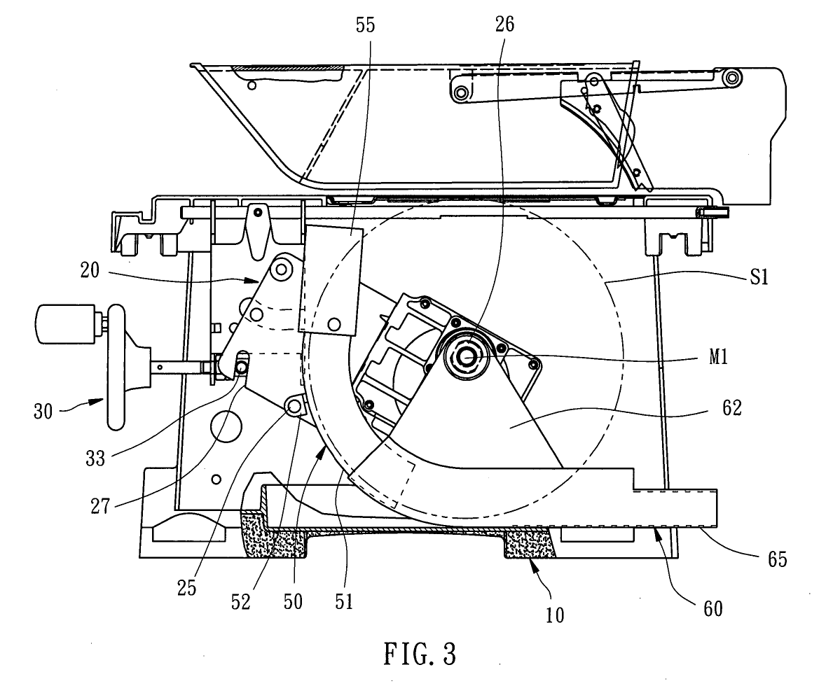

When operating the control assembly 30 to pivotally rotate the blade holder 20 so as to lift the saw blade S1, as shown in FIG. 1, the first dust collector 50 is moved together with the blade holder 20, no relative movement between them, and the flexible guard 55 is deformed suitably to contact the bottom side of the worktable 12. At the same time, the second dust collector 60 is lifted by the rotating shaft M1 of the motor assembly and rotates pivotally relative to the blade holder 20 to keep downward position as a result of gravity. Therefore, the first dust collector 50 shrinks into the second dust collector 60 so that first dust collector 50 and the second dust collector 60 overlap each other to keep a covering over the saw blade S1. On the contrary, when operating the control assembly 30 in the reverse direction to lower the saw blade S1, as shown in FIG. 3, the first dust collector 50 is also moved together with the blade holder 20, and the second dust collector 60 is lowered under keeping the downward position as a result of gravity. Therefore, the first dust collector 50 stretches from the second dust collector 60, but the first dust collector 50 and the second dust collector 60 still overlap each other to keep the covering over the saw blade S1.

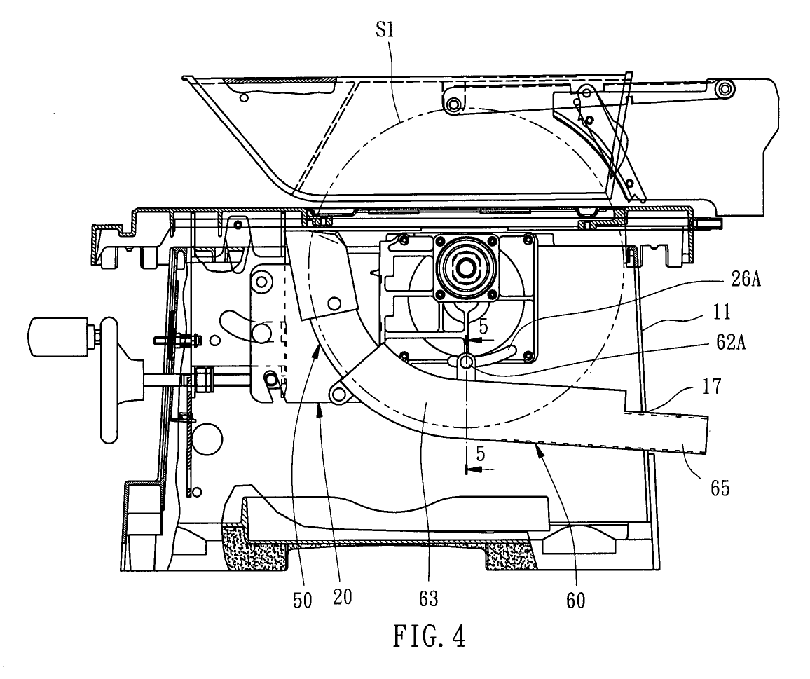

FIGS. 4 and 5 show an alternate embodiment of the present invention. According to this embodiment, the second dust collector mounting portion 26A of the blade holder 20 is an arched slot 26A, the mounting portion 62A of the second dust collector 60 has a rod, and the slot 26A has a third curve defined by a third radius around the center of the rotating shaft. The mounting portion 62A extends from guarding portion 63, and the rod extends through the arched slot 26A and is slidable along the arched slot 26A. The dust pipe connect portion 65 of the second dust collector 60 is extended through the base 11 and substantially matches the through hole 17 of the base 11. In another form that the dust pipe connect portion 65 has not to matches the through hole 17, the mounting portion 62A of the second dust collector 60 has two rod both of which are through the arched slot 26A. By the foresaid means, the first dust collector 50 can stretch from or shrinks into the second dust collector 60 and hence, when lifting or lowering the saw blade S1, the dust collectors 50, 60 move relatively and keep overlapping.

As indicated above, the circular saw machine of the present invention has the following benefits:

1. The dust collectors 50, 60 of the circular saw machine are relatively movable according to lifting or lowering the saw blade S1 so as to form a coupled covering over the saw blade S1 in any operation. Therefore, the workpiece chips and dust during operation of the circular saw machine can be well collected and carried out of the circular saw machine, achieving the best clean effect.

2. The dust collectors 50, 60 of the circular saw machine have a simple structure and are easy to be installed.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A circular saw machine comprising:
a body having a base, a worktable mounted on said base, and a receiving space defined in said base;
a saw blade placed in said receiving space and adjusted through said worktable;
a motor assembly having a rotating shaft extended through a center of said saw blade;
a blade holder received inside said receiving space, connected to said body, and holding said rotating shaft;
a control assembly coupled to said blade holder for moving said blade holder so as to adjust a height of said saw blade above said worktable;
a first dust collector fixedly connected to said blade holder and covering a part rim of said saw blade; and
a second dust collector covering another part rim of said saw blade, and movably overlapping with said first dust collector.

2. The circular saw machine as claimed in claim 1, wherein said first dust collector has a rigid guard fixed on said blade holder, and a flexible guard connecting with said rigid guard and adjacent to a bottom side of said worktable.

3. The circular saw machine as claimed in claim 1, wherein said first dust collector has a first curve defined by a first radius around a center of said rotating shaft and said first radius of said first curve is larger than a radius of a rim of said saw blade.

4. The circular saw machine as claimed in claim 3, wherein said second dust collector has a second curve defined by a second radius around the center of said rotating shaft and said second radius of said second curve is larger than said first radius of said first curve.

5. The circular saw machine as claimed in claim 1, wherein said first dust collector is inserted into an inner space of said second dust collector.

6. The circular saw machine as claimed in claim 1, wherein said second dust collector extends through said base.

7. The circular saw machine as claimed in claim 1, wherein said second dust collector is pivotally connected to said blade holder.

8. The circular saw machine as claimed in claim 7, wherein a pivotal center of said second dust collector is the same as a center of said rotating shaft.

9. The circular saw machine as claimed in claim 1, wherein one of said second dust collector and said blade holder is opened a slot and the other has a rod extending through said slot.

10. The circular saw machine as claimed in claim 9, wherein said slot has a third curve defined by a third radius around a center of said rotating shaft.

11. The circular saw machine as claimed in claim 1, wherein said blade holder is pivotally coupled to said body.

12. The circular saw machine as claimed in claim 11, wherein said control assembly has a link part coupled to said blade holder, and a threaded rod screwingly jointing said link part.

13. The circular saw machine as claimed in claim 12, wherein said control assembly further has a wheel connected to a terminal of said threaded rod.
